(19) United States
(12) Patent Application Publication
(10) Pub. No.: US 2024/0290350 A1
(43) Pub. Date: Aug. 29, 2024

(54) GLASS PLATE, DISK-SHAPED GLASS, MAGNETIC DISK GLASS SUBSTRATE, AND METHOD FOR MANUFACTURING GLASS PLATE

(71) Applicant: HOYA CORPORATION, Shinjuku-ku, Tokyo (JP)

(72) Inventors: Kazuaki HASHIMOTO, Akiruno-shi, Tokyo (JP); Masanori TAMAKI, Higashimurayama-shi, Tokyo (JP)

(21) Appl. No.: 18/572,677

(22) PCT Filed: Jul. 5, 2022
(86) PCT No.: PCT/JP2022/026729

§ 371 Date: Dec. 20, 2023

(30) Foreign Application Priority Data
Jul. 5, 2021 (WO) PCT/JP2021/025369

(51) Int. Cl. G11B 5/73; C03B 25/02

(52) U.S. Cl. CPC G11B 5/73921; C03B 25/025

(57) ABSTRACT

A glass plate is a rectangular plate having a thickness less than 0.68 mm. A square measurement region having a length of 100 mm per side and cut out from a central region of the glass plate has a degree of flatness of 30 μm or less. When subjected to first heat treatment in which the measurement region is kept at 700° C. for 4 hours and then cooled from 700° C. to 400° C. at a rate of 50° C./hour, the measurement region has a thermal contraction rate of 130 ppm or less. When subjected to second heat treatment in which the measurement region is kept at Tg-160° C. for 60 seconds and then cooled to room temperature in ambient air, where Tg (° C.) represents a glass transition temperature of the glass plate, an amount of change in the degree of flatness of the measurement region is 10 μm or less.

### CROSS-REFERENCE TO RELATED APPLICATIONS

This is a U.S. National stage application of International Patent Application No. PCT/JP2022/026729, filed on Jul. 5, 2022, which, in turn, claims priority to International Patent Application No. PCT/JP2021/025369, filed on Jul. 5, 2021. The entire contents of International Patent Application Nos. PCT/JP2022/026729 and PCT/JP2021/025369 are hereby incorporated herein by reference.

### BACKGROUND

### Field of the Invention

The present invention relates to a glass substrate for a magnetic disk used in a hard disk drive device, a disk-shaped glass, a glass plate, and a method for manufacturing a glass plate.

### Background Information

Following the expansion of cloud computing in recent years, many hard disk drive (HDD) devices are used in data centers for a cloud in order to increase the storage capacity. A magnetic disk obtained by providing a magnetic layer on an annular nonmagnetic glass substrate for a magnetic disk is used as a storage medium in an HDD device. In order to increase the storage capacity of an HDD device, it is preferable to increase the number of magnetic disks mounted in the HDD device by mounting a large number of thin magnetic disks, in addition to increasing the recording density of the magnetic disks.

In order to increase the recording density consideration has been given to the use of heat-assisted magnetic recording (HAMR) and microwave-assisted magnetic recording (MAMR) as recording methods for magnetic disks, in addition to conventional perpendicular magnetic recording. In recent years, heat treatment is performed on a magnetic film in order to form a magnetic recording layer suitable for these recording methods. The heat treatment is performed by heating a glass substrate at a high temperature after a magnetic film is formed thereon or heating a glass substrate at a high temperature while forming a magnetic film thereon, for example. At this time, the temperature of the magnetic film may far exceed 600° C. and reach 700° C. or higher. In the heat treatment, the glass substrate is heated as well as the magnetic film, and therefore, a magnetic disk glass substrate is required to have a high degree of heat resistance, i.e., a high glass transition temperature (Tg) so that the glass substrate will not deform when heated.

As a method for manufacturing a glass plate that is used to manufacture a magnetic disk glass substrate, it is possible to use a pressing method, a float method, a Fourcault method, a Pittsburgh method, a downdraw method, a Colburn method, a redraw method, or the like. Among these methods, the float method, the Fourcault method, the Pittsburgh method, the downdraw method, the Colburn method, and the redraw method are preferably used to manufacture a glass substrate for a flat panel display (FPD) such as a liquid crystal display because a large glass plate can be manufactured more easily with use of these methods when compared with the pressing method.

A glass substrate provided with electronic elements such as a thin film transistor (TFT) is used for an FPD. In a process for manufacturing the TFT, the glass substrate is heated to a high temperature, and accordingly there is a problem that thermal contraction of the glass substrate occurs and dimensions of the glass substrate are likely to change. Therefore, when a glass plate is manufactured using any of the above-described methods such as the float method, the glass plate is annealed while being formed, and annealing conditions are adjusted to reduce residual stress in the glass plate and reduce a thermal contraction rate. Also, off-line annealing is known as a method for further reducing the thermal contraction rate of a glass plate. In the off-line annealing, heat treatment is performed on a glass plate that has been cut to a predetermined size from an elongated formed glass sheet (JP 2017-178711A).

### SUMMARY

It was found that, when a magnetic disk glass substrate is manufactured from a glass plate that is manufactured using any of the above-described methods such as the float method and has a high glass transition temperature (Tg) and a magnetic disk is manufactured using the magnetic disk glass substrate, the glass substrate warps during thermal contraction caused by heat treatment performed on the magnetic film, and the degree of flatness of the magnetic disk deteriorates. It was also found that such deterioration in the degree of flatness is noticeable particularly when a thin magnetic disk glass substrate is used. If the degree of flatness of a magnetic disk is poor, fluttering is likely to occur in an HDD device, and stable reading cannot be performed.

Under the above circumstances, the present invention has an object of providing a magnetic disk glass substrate that can suppress deterioration in the degree of flatness caused by heat treatment performed to form a magnetic recording layer of a magnetic disk, a disk-shaped glass and a glass plate used to obtain such a magnetic disk glass substrate, and a method for manufacturing the glass plate.

An aspect of the present invention is a glass plate.

The glass plate is a rectangular glass plate having a thickness less than 0.68 mm.

A square measurement region having a length of 100 mm per side and cut out from a central region of the glass plate has a degree of flatness of 30 μm or less, the central region being a region excluding: end regions of the glass plate extending inward from respective edges of the glass plate in a short-side direction, with a length that is 5% to 20% of a length of each short side of the glass plate; and end regions of the glass plate extending inward from respective edges of the glass plate in a long-side direction, with a length that is 5% to 20% of a length of each long side of the glass plate.

When the measurement region is subjected to first heat treatment in which the measurement region is kept at 700° C. for 4 hours and then cooled from 700° C. to 400° C. at a rate of 50° C./hour, the measurement region has a thermal contraction rate of 130 ppm or less.

When the measurement region is subjected to second heat treatment in which the measurement region is kept at Tg-160° C. for 60 seconds and then cooled to room temperature in ambient air, where Tg (° C.) represents a glass transition temperature of the glass plate, an amount of change in the degree of flatness of the measurement region is 10 μm or less.

It is preferable that the length of each short side is more than 900 mm.

It is preferable that the glass plate is a portion cut out from an elongated glass sheet formed with use of any one of a float method, a Fourcault method, a Pittsburgh method, a downdraw method, a Colburn method, and a redraw method.

It is preferable that a difference between a thermal contraction amount S1 of the measurement region in a direction in which the thermal contraction rate is the lowest and a thermal contraction amount S2 of the measurement region in a direction in which the thermal contraction rate is the highest among directions along a surface of the measurement region is 1.0 μm or less.

The glass plate may be a glass plate that has been subjected to annealing treatment for reducing the thermal contraction rate.

The glass plate prior to being subjected to the annealing treatment may have anisotropy in the thermal contraction rate and variation in the thermal contraction rate between different directions along a surface of a region of the glass plate corresponding to the measurement region, and a difference between a thermal contraction amount S1 of the region in a direction in which the thermal contraction rate is the lowest and a thermal contraction amount S2 of the region in a direction in which the thermal contraction rate is the highest among directions along the surface may be larger than 1.0 μm.

Another aspect of the present invention is a glass plate.

The glass plate is a rectangular glass plate having a thickness less than 0.68 mm, a degree of flatness of 30 μm or less, and two sides that are orthogonal to each other and each have a length of 95 to 120 mm.

When the glass plate is subjected to first heat treatment in which the glass plate is kept at 700° C. for 4 hours and then cooled from 700° C. to 400° C. at a rate of 50° C./hour, the glass plate has a thermal contraction rate of 130 ppm or less.

When the glass plate is subjected to second heat treatment in which the glass plate is kept at Tg-160° C. for 60 seconds and then cooled to room temperature in ambient air, where Tg (° C.) represents a glass transition temperature of the glass plate, an amount of change in the degree of flatness is 10 μm or less.

It is preferable that the rectangular glass plate is a glass blank from which a disk-shaped glass having a circular outer circumferential edge is obtained, and
an area of a main surface of the rectangular glass plate is not larger than 1.6 times an area inside the outer circumferential edge of the disk-shaped glass.

Another aspect of the present invention is a disk-shaped glass.

The disk-shaped glass has a thickness less than 0.68 mm, a degree of flatness of 30 μm or less, and a circular outer circumferential edge having a diameter of 95 to 100 mm.

When the disk-shaped glass is subjected to first heat treatment in which the disk-shaped glass is kept at 700° C. for 4 hours and then cooled from 700° C. to 400° C. at a rate of 50° C./hour, the disk-shaped glass has a thermal contraction rate of 130 ppm or less.

When the disk-shaped glass is subjected to second heat treatment in which the disk-shaped glass is kept at Tg-160° C. for 60 seconds and then cooled to room temperature in ambient air, where Tg (° C.) represents a glass transition temperature of the disk-shaped glass, an amount of change in the degree of flatness is 10 μm or less.

Another aspect of the present invention is a magnetic disk glass substrate.

The magnetic disk glass substrate has a thickness less than 0.68 mm, a degree of flatness of 30 μm or less, and a diameter of 95 to 100 mm.

When the magnetic disk glass substrate is subjected to first heat treatment in which the magnetic disk glass substrate is kept at 700° C. for 4 hours and then cooled from 700° C. to 400° C. at a rate of 50° C./hour, the magnetic disk glass substrate has a thermal contraction rate of 130 ppm or less.

When the magnetic disk glass substrate is subjected to second heat treatment in which the magnetic disk glass substrate is kept at Tg-160° C. for 60 seconds and then cooled to room temperature in ambient air, where Tg (° C.) represents a glass transition temperature of the magnetic disk glass substrate, an amount of change in the degree of flatness is 10 μm or less.

It is preferable that an amount of change in roundness due to the first heat treatment is 0.5 μm or less.

Another aspect of the present invention is a method for manufacturing a glass plate.

The method for manufacturing a glass plate includes: a step for performing annealing treatment on a glass plate member from which the glass plate is obtained.

The glass plate is a rectangular plate having a thickness less than 0.68 mm.

A square measurement region having a length of 100 mm per side and cut out from a central region of the glass plate has a degree of flatness of 30 μm or less, the central region being a region excluding: end regions of the glass plate extending inward from respective edges of the glass plate in a short-side direction, with a length that is 5% to 20% of a length of each short side of the glass plate; and end regions of the glass plate extending inward from respective edges of the glass plate in a long-side direction, with a length that is 5% to 20% of a length of each long side of the glass plate.

When the measurement region is subjected to first heat treatment in which the measurement region is kept at 700° C. for 4 hours and then cooled from 700° C. to 400° C. at a rate of 50° C./hour, the measurement region has a thermal contraction rate of 130 ppm or less.

When the measurement region is subjected to second heat treatment in which the measurement region is kept at Tg-160° C. for 60 seconds and then cooled to room temperature in ambient air, where Tg (° C.) represents a glass transition temperature of the glass plate, an amount of change in the degree of flatness of the measurement region is 10 μm or less.

Another aspect of the present invention is a method for manufacturing a glass plate.

The method for manufacturing a glass plate includes:
a step for performing annealing treatment on a glass plate member from which the glass plate is obtained; and
a step for taking out the glass plate from the glass plate member after the annealing treatment,
wherein the glass plate is a rectangular plate having a thickness less than 0.68 mm, a degree of flatness of 30 μm or less, and two sides that are orthogonal to each other and each have a length of 95 to 120 mm.

When the glass plate is subjected to first heat treatment in which the glass plate is kept at 700° C. for 4 hours and then cooled from 700° C. to 400° C. at a rate of 50° C./hour, the glass plate has a thermal contraction rate of 130 ppm or less.

When the glass plate is subjected to second heat treatment in which the glass plate is kept at Tg-160° C. for 60 seconds and then cooled to room temperature in ambient air, where Tg (° C.) represents a glass transition temperature of the glass plate, an amount of change in the degree of flatness is 10 μm or less.

It is preferable that the rectangular glass plate is a square glass blank from which a disk-shaped glass having a circular outer circumferential edge is obtained, and
an area of a main surface of the rectangular glass plate is not larger than 1.6 times an area inside the outer circumferential edge of the disk-shaped glass.

Another aspect of the present invention is a method for manufacturing a glass plate.

The method for manufacturing a glass plate is a method for manufacturing a disk-shaped glass, and includes:
a step for performing annealing treatment on a glass plate member from which the disk-shaped glass is obtained; and
a step for taking out the disk-shaped glass from the glass plate member after the annealing treatment,
wherein the glass plate member is a rectangular glass plate,
the disk-shaped glass has a thickness less than 0.68 mm, a degree of flatness of 30 μm or less, and a diameter of 95 to 100 mm,
when the disk-shaped glass is subjected to first heat treatment in which the disk-shaped glass is kept at 700° C. for 4 hours and then cooled from 700° C. to 400° C. at a rate of 50° C./hour, the disk-shaped glass has a thermal contraction rate of 130 ppm or less, and
when the disk-shaped glass is subjected to second heat treatment in which the disk-shaped glass is kept at Tg-160° C. for 60 seconds and then cooled to room temperature in ambient air, where Tg (° C.) represents a glass transition temperature of the disk-shaped glass, an amount of change in the degree of flatness is 10 μm or less.

It is preferable that the rectangular glass plate has a square shape, and
an area of a main surface of the rectangular glass plate is not larger than 1.6 times an area inside the outer circumferential edge of the disk-shaped glass.

With the magnetic disk glass substrate described above, it is possible to suppress deterioration in the degree of flatness caused by heat treatment performed to form a magnetic recording layer of a magnetic disk. With the glass plate and the disk-shaped glass described above, it is possible to obtain such a magnetic disk glass substrate. With the method for manufacturing a glass plate described above, it is possible to obtain the glass plate described above.

### BRIEF DESCRIPTION OF THE DRAWINGS

FIG. 1A is a diagram showing the appearance of a glass plate (a large glass plate), which is an embodiment, and FIG. 1B is a plan view showing a measurement region of the glass plate.

FIG. 2A is a diagram showing the appearance of a glass plate (a divided glass plate), which is an embodiment, and FIG. 2B is a plan view of the glass plate in which a portion to be formed into a disk-shaped glass is shown.

FIG. 3 is a diagram showing the appearance of a disk-shaped glass, which is an embodiment.

FIG. 4 is a diagram showing the appearance of a magnetic disk glass substrate, which is an embodiment.

### DETAILED DESCRIPTION OF THE EMBODIMENTS

The following describes a glass plate according to an embodiment, a method for manufacturing the glass plate, a disk-shaped glass, and a magnetic disk glass substrate in detail.

### (Large Glass Plate)

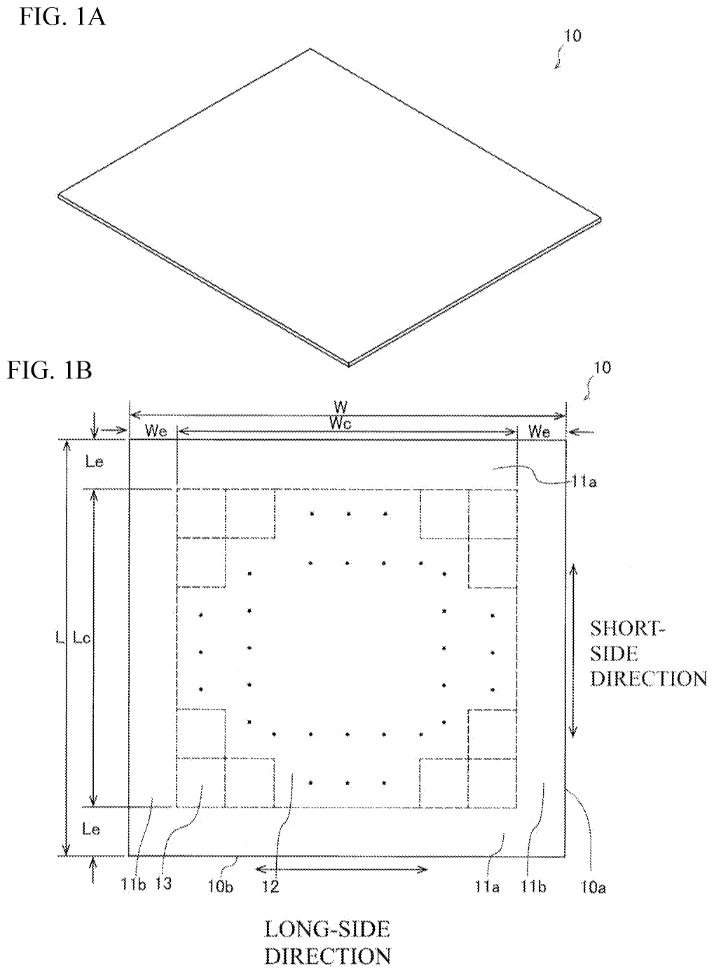

FIG. 1A is a diagram showing the appearance of a glass plate 10 according to an embodiment. FIG. 1B is a plan view showing a measurement region 13 of the glass plate 10, which will be described later.

The glass plate 10 is a rectangular plate having a thickness less than 0.68 mm.

The thickness of the glass plate 10 is less than 0.68 mm, and therefore, it is possible to obtain a thin magnetic disk by using a magnetic disk glass substrate (hereinafter also referred to as a “glass substrate”) manufactured from the glass plate 10 and to increase the number of magnetic disks mounted in an HDD device. The thickness of the glass plate 10 is preferably less than 0.61 mm, and more preferably less than 0.58 mm. The lower limit of the thickness of the glass plate 10 is not particularly limited, and is, for example, 0.2 mm.

Preferably short sides of the glass plate 10 each have a length exceeding 900 mm. In this case, it is possible to manufacture many magnetic disk glass substrates from the glass plate 10 and reduce the manufacturing cost of the magnetic disk glass substrates. The length of long sides of the glass plate 10 may be longer than the length of the short sides as in the example shown in FIG. 1, or equal to the length of the short sides. That is, the glass plate 10 has a rectangular shape or a square shape. In the case where the glass plate 10 has short sides and long sides, the ratio between the length of a long side and the length of a short side (length of long side+length of short side) is preferably 1.2 or less. When precise annealing, which will be described later, is performed on a glass plate member from which the glass plate 10 having the ratio of 1.2 or less is obtained, it is easy to reduce the thermal contraction rate and suppress anisotropy in the thermal contraction rate (which will be described later). This is presumably because, in the case where the shape of a workpiece is close to a square shape, a difference in thermal history is unlikely to occur between different positions in a surface of the workpiece during annealing. Such a glass plate having short sides each having a length exceeding 900 mm may be referred to as a “large glass plate” in the present specification. Note that the length of the long side of the glass plate 10 is preferably 2000 mm or less. When the length of the long side is more than 2000 mm, it may be difficult to keep the temperature inside a furnace uniform during precise annealing, which will be described later.

A measurement region 13 cut out from a central region of the glass plate 10 has a degree of flatness of 30 μm or less. When the degree of flatness of the measurement region 13 is 30 μm or less, the grinding or polishing allowance can be reduced when a magnetic disk glass substrate is manufactured from the glass plate 10 and it is possible to manufacture the magnetic disk glass substrate with a good yield. Also, when the degree of flatness of the measurement region 13 is 30 μm or less, fluttering is unlikely to occur when a magnetic disk manufactured from the glass plate 10 is rotated at a high speed, and a head of a reading unit of an HDD device can stably perform reading. Particularly when the magnetic disk is thin, the rigidity of the glass substrate is low, and therefore, the glass substrate may warp, which leads to fluttering. However, when the value of the degree of flatness of the glass substrate 10 is small, fluttering can be suppressed even if the magnetic disk is thin.

The degree of flatness referred to in the present specification means the degree of flatness in accordance with JIS B0621-1984. The degree of flatness can be measured using phase measuring interferometry (phase shift method) performed at a predetermined measurement wavelength (e.g., 680 nm) with use of an interference-type flatness measuring device, for example. The degree of flatness of the measurement region 13 is preferably 20 μm or less, and more preferably 10 μm or less. Note that the degree of flatness described above is a degree of flatness of the measurement region 13 prior to being subjected to first or second heat treatment, which will be described later. The same also applies to the following description, unless otherwise stated.

A central region 12 of the glass plate 10 is a region of the glass plate 10 excluding: end regions 11a extending inward from respective edges of the glass plate 10 in a short-side direction, with a length Le that is 5% to 20% of the length L of each short side 10a of the glass plate 10; and end regions 11b extending inward from respective edges of the glass plate 10 in a long-side direction, with a length We that is 5% to 20% of the length W of each long side 10b of the glass plate 10. The central region 12 has a length Lc in the short-side direction and a length We in the long-side direction.

The measurement region 13 is a square region having a length of 100 mm per side and cut out from the central region 12 of the glass plate 10. The measurement region 13 does not need to be cut out in the manner shown in FIG. 1B, and may be cut out in a suitable manner from the central region 12. The size and shape of the measurement region 13 are close to the size and shape of a glass plate (“divided glass plate”, which will be described later) from which a magnetic disk glass substrate is obtained.

The inventors of the present invention found through studies that an effect described below can be obtained when: a thermal contraction rate of the measurement region 13 is 130 ppm or less when the measurement region 13 is subjected to first heat treatment in which the measurement region 13 is kept at 700° C. for 4 hours and then cooled from 700° C. to 400° C. at a rate of 50° C./hour; and an amount of change in the degree of flatness of the measurement region 13 is 10 μm or less when the measurement region 13 is subjected to second heat treatment in which the measurement region 13 is kept at Tg-160° C. for 60 seconds and then cooled to room temperature in ambient air, where Tg (° C.) represents the glass transition temperature of the glass plate 10. That is, it was found that, when heat treatment is performed on a magnetic film on a magnetic disk glass substrate manufactured from the glass plate 10 having a thickness smaller than 0.68 mm and including the measurement region 13 having a degree of flatness of 30 μm or less, thermal contraction of the glass substrate is suppressed, and accordingly the glass substrate is kept from warping due to thermal contraction, and consequently deterioration in the degree of flatness of the glass substrate can be suppressed. Owing to this effect, deterioration in the degree of flatness of the glass plate 10, which is 30 μm or less, is suppressed in the glass substrate after the heat treatment performed on the magnetic film, and fluttering is suppressed when a magnetic disk manufactured using the glass substrate is rotated at a high speed.

For the reasons described above, the glass plate 10 according to the present embodiment is configured such that: the thermal contraction rate of the measurement region 13 is 130 ppm or less when the measurement region 13 is subjected to the first heat treatment in which the measurement region 13 is kept at 700° C. for 4 hours and then cooled from 700° C. to 400° C. at a rate of 50° C./hour; and the amount of change in the degree of flatness of the measurement region 13 is 10 μm or less when the measurement region 13 is subjected to the second heat treatment in which the measurement region 13 is kept at Tg-160° C. for 60 seconds and then cooled to room temperature in ambient air. When the thermal contraction rate of the measurement region 13 subjected to the first heat treatment is more than 130 ppm and the amount of change in the degree of flatness of the measurement region 13 subjected to the second heat treatment is more than 10 μm, it is not possible to suppress warpage of the glass substrate due to thermal contraction, and the degree of flatness of the glass plate deteriorates. A high degree of flatness of 30 μm or less is significantly impaired even by slight thermal contraction.

The conditions of the first heat treatment and the second heat treatment are determined with reference to conditions of heat treatment performed on the magnetic film. The conditions of the first heat treatment are determined from the viewpoint of setting temperature conditions that enable evaluation of the thermal contraction rate through heating performed at a high temperature for a long period of time, which is presumed to be related to the deterioration in the degree of flatness of the glass substrate when heat treatment is performed on the magnetic film at a temperature higher than or equal to 600° C. The conditions of the second heat treatment are determined from the viewpoint of setting temperature conditions that enable direct evaluation of the amount of deterioration in the degree of flatness of the glass substrate when heat treatment is performed on the magnetic film at a temperature higher than or equal to 600° C. This is because a magnetic film having an L1₀ structure, which is thought to be optimum for energy-assisted magnetic recording (EAMR) such as heat-assisted magnetic recording (HAMR) or microwave-assisted magnetic recording (MAMR), may be formed at a temperature far exceeding 600° C. and reaching 700° C. or higher.

The thermal contraction rate referred to in the present specification is a thermal contraction rate of a size measured before and after the first heat treatment, unless otherwise stated, and means the largest value of thermal contraction rates measured in 25 directions that are parallel to a main surface of the measurement target, pass through the center of the measurement target, and are set at intervals of 7.2° in a circumferential direction. When the thermal contraction rate is measured as described above, the thermal contraction rate can be measured in all directions (360°), and therefore, can be evaluated more accurately when compared with conventional methods.

Heating (temperature raising), temperature maintaining, and cooling (temperature lowering) in the first heat treatment are preferably performed successively in an atmosphere under the same conditions (e.g., in an atmosphere in the same annealing furnace) except for the temperature conditions. Heating in the first heat treatment is preferably performed for 2.5 hours starting from room temperature (normal temperature). In other words, the treatment target substrate is preferably heated from room temperature to 700° C. at a rate of 270° C./hour. Cooling (temperature lowering) is preferably performed from 700° C. to room temperature at a rate of 50° C./hour.

Note that the first heat treatment is preferably performed in a state where the treatment target substrate (which may be the measurement region 13 of the glass plate 10, or a glass plate 20, a disk-shaped glass 30, or a magnetic disk glass substrate 40, which will be described later) is placed horizontally and sandwiched in an up-down direction by two setters, which will be described later, in order to avoid significant deterioration in the degree of flatness. By avoiding significant deterioration in the degree of flatness, it is possible to accurately measure the thermal contraction rate. Setters that have a size larger than or equal to the treatment target substrate are used. The thickness of a setter placed on the treatment target substrate can be set such that the setter has a weight that does not hinder thermal contraction of the treatment target substrate and allows the treatment target substrate to substantially maintain the degree of flatness (e.g., keep the degree of flatness at 30 μm or less). It goes without saying that a heavy setter is inappropriate for a thin treatment target substrate. When the degree of flatness of the treatment target substrate is substantially maintained, it is possible to evaluate the amount of change in the degree of flatness due to the second heat treatment, which will be described later, by using the same treatment target substrate after evaluating the thermal contraction rate in the first heat treatment.

Note that different treatment target substrates may be used in evaluation of the thermal contraction rate in the first heat treatment and evaluation of the amount of change in the degree of flatness caused by the second heat treatment, which will be described later.

Cooling the treatment target substrate in ambient air in the second heat treatment means leaving the treatment target substrate to cool in an atmosphere at room temperature without adjusting the temperature to control the cooling rate. The room temperature is 25° C., for example. In the second heat treatment, the substrate is heated and the temperature of the substrate is maintained in a state where the substrate is held by a substrate holder in an atmosphere between two panel-shaped heaters in a heating device including the heaters, for example. The heating device is similar to a substrate heating chamber included in a known vacuum film deposition device for single wafer processing, which is used to form magnetic films on magnetic disks, for example. The substrate is set in a known substrate holder (also called “a carrier”) for film deposition in such a manner as to extend vertically with respect to the ground. Three or four L-shaped leaf springs are fixed as support members to the substrate holder (e.g., a substrate holder described in paragraph 0045 and shown in, for example, FIG. 4 of JP 2011-117019A), and the substrate is fixed to the substrate holder using the elasticity of the leaf springs by pressing leading ends of the leaf springs against an outer circumferential edge surface of the substrate. Not only a circular substrate but also a substrate having, for example, a rectangular shape can be held in the same manner. It is possible to heat substrates of various shapes in the same manner by adjusting the specifications of the substrate holder. Note that a force generated by the elasticity of the leaf springs is constantly applied to the substrate by the support members in such a manner as to warp the substrate, and therefore, consideration needs to be given to the fact that the substrate is more likely to warp when compared with a case where the substrate is heated without the support member being used (e.g., a case where the substrate is placed horizontally).

The thermal contraction rate is calculated by measuring a change in a length in the measurement region 13 between before and after the heat treatment and using the following formula, for example.

C(thermal contraction rate)=(L₀−L)/L₀

Here, L₀ represents the length before the heat treatment, and L represents the length after the heat treatment. The value C takes a plus sign when the measurement region has contracted as a result of the heat treatment, and takes a minus sign when the measurement region has expanded.

For example, L₀ and L are obtained by marking two points on a surface of the measurement region 13 that has been cut out, and measuring the distance between the two marks before and after the heat treatment. Alternatively L₀ and L may also be lengths of the measurement region 13 before and after the heat treatment. Preferably these lengths are the length of a line passing through the center of the measurement region 13. In the case where the measurement target is a disk-shaped glass or a magnetic disk glass substrate, the diameter may also be used.

Anisotropy in the thermal contraction rate can be evaluated using lengths (e.g., diameters) measured in 25 directions set at intervals of 7.2° in the circumferential direction about the center of the measurement target, for example. An index of the anisotropy in the thermal contraction rate can be obtained by measuring the thermal contraction rate in the 25 directions, and taking the absolute value of a difference obtained by subtracting the lowest thermal contraction rate from the highest thermal contraction rate. It is also possible to obtain an index of the anisotropy by using thermal contraction amounts (S) instead of the thermal contraction rates (C), and taking the absolute value of a difference between the largest thermal contraction amount and the smallest thermal contraction amount among the thermal contraction amounts measured in the 25 directions. S (thermal contraction amount) is calculated as follows: S=(L₀−L).

The thermal contraction rate of the measurement region 13 subjected to the first heat treatment is preferably 90 ppm or less, and more preferably 50 ppm or less. The amount of change in the degree of flatness of the measurement region 13 subjected to the second heat treatment is preferably 7.5 μm or less, and more preferably 5 μm or less.

The glass plate 10 is preferably a portion cut out from an elongated glass sheet formed using any one of the float method, the Fourcault method, the Pittsburgh method, the downdraw method, the Colburn method, and the redraw method. A large glass plate 10 can be obtained from a glass sheet formed using any of these methods, and accordingly it is possible to obtain, from the glass plate 10, a large number of divided glass plates from which magnetic disk glass substrates are formed, and it is possible to reduce the manufacturing cost of the magnetic disk glass substrates. Also, these methods are advantageous in forming a glass sheet having a high glass transition temperature (Tg), and accordingly it is possible to reduce the manufacturing cost of a glass plate 10 having a high glass transition temperature (Tg). Specific examples of the downdraw method include a slot downdraw method and an overflow downdraw method. Also, it is preferable that at least one main surface of the glass plate 10 is a fire finished surface. In this case, it is possible to omit one of grinding processing and polishing processing, which commonly need to be performed on a main surface of a magnetic disk glass substrate in manufacturing the magnetic disk glass substrate, or reduce the grinding allowance or polishing allowance. In other words, at least one main surface of the glass plate 10 is preferably a non-ground and/or non-polished surface.

In a glass sheet obtained using any of the above-described methods such as the float method, both end portions of the glass sheet in a width direction orthogonal to a longitudinal direction of the glass sheet (the direction in which glass flows out from a melting furnace) are commonly thicker than a center portion of the glass sheet in the width direction, and therefore, a glass plate member from which the glass plate 10 is obtained is cut out from a portion of the glass sheet that remains after both end portions of the glass sheet in the width direction are cut off. The glass plate member from which the glass plate 10 is obtained is commonly cut out in such a manner that the width direction of the glass sheet matches the short-side direction or the long-side direction of the glass plate 10.

The glass plate 10 may have anisotropy in the thermal contraction rate. Anisotropy in the thermal contraction rate is a variation in the thermal contraction rate between various directions along a main surface of the measurement region 13. The inventors of the present invention found through studies that, when the glass plate 10 has anisotropy in the thermal contraction rate, there is a risk of the roundness (JIS B0621-1984) of a magnetic disk glass substrate obtained from the glass plate 10 deteriorating when heat treatment is performed on a magnetic film on the glass substrate. Particularly in the case where a glass plate member from which the glass plate 10 is obtained is a portion cut out from a glass sheet formed using any of the above-described methods such as the float method, the thermal contraction rate is likely to vary between different directions along a surface of the glass sheet, and the glass plate 10 is likely to have anisotropy in the thermal contraction rate. Furthermore, the inventors of the present invention also found that a direction in which the thermal contraction rate is the highest and a direction in which the thermal contraction rate is the lowest among directions along the main surface are not necessarily orthogonal to each other. That is, anisotropy in the thermal contraction rate has been conventionally evaluated by measuring the thermal contraction rate in two directions, i.e., the longitudinal direction of the glass sheet and the width direction of the glass sheet, which is orthogonal to the longitudinal direction, and taking a difference between the measured thermal contraction rates to be an index of anisotropy, but it was found that the highest thermal contraction rate, the lowest thermal contraction rate, and a difference therebetween may not be accurately evaluated using this method. Reasons for this are not entirely clear, but presumably because, in a method for continuously forming an elongated glass sheet, such as the float method or the downdraw method, glass flowing out from a melting furnace or a softening furnace is commonly formed into a glass sheet while moving in the flowing direction by being pulled in the flowing direction and extended in the width direction as well, and accordingly the glass is also pulled in a diagonal direction that is a composite direction of the two orthogonal directions. Also, the direction in which the glass is pulled varies according to conditions for forming the glass sheet and positions in the glass sheet, and also varies over time. Moreover, thermal history also varies according to the positions, and it is thought that therefore, the direction in which the thermal contraction rate is the highest, the direction in which the thermal contraction rate is the lowest, and values of the thermal contraction rate vary. Therefore, in order to precisely evaluate anisotropy, it is necessary to cut out a desired glass plate from the elongated glass sheet and examine the glass plate in all directions.

When the roundness of an outer circumferential edge of the magnetic disk glass substrate deteriorates as described above, fluttering is likely to occur due to the magnetic disk slightly shifting when it is rotated at a high speed. Therefore, it is very important to precisely grasp the direction in which the thermal contraction rate is the highest, the direction in which the thermal contraction rate is the lowest, values of the thermal contraction rate in these directions, and a difference between the values, as for the magnetic disk glass substrate, a disk-shaped glass from which the magnetic disk glass substrate is obtained, and the glass plate from which the disk-shaped glass is obtained. From the viewpoint of suppressing such deterioration in the roundness of the glass substrate, a difference (the absolute value thereof) between a thermal contraction rate C1 in the direction in which the thermal contraction rate is the lowest and a thermal contraction rate C2 in the direction in which the thermal contraction rate is the highest among directions along the surface of the measurement region 13 is preferably 10 ppm or less. Also, a difference (the absolute value thereof) between a thermal contraction amount S1 of the measurement region in the direction in which the thermal contraction rate is the lowest and a thermal contraction amount S2 of the measurement region in the direction in which the thermal contraction rate is the highest is preferably 1.0 μm or less.

Preferably the glass plate 10 is a glass plate that has been subjected to annealing treatment (e.g., “precise annealing”, which will be described later) for reducing the thermal contraction rate. The glass plate prior to being subjected to the annealing treatment (the glass plate member from which the glass plate 10 is obtained) may have anisotropy in the thermal contraction rate, i.e., variation in the thermal contraction rate between different directions along a surface of a region of the glass plate corresponding to the measurement region 13, and a difference (the absolute value thereof) between a thermal contraction rate C1 in a direction in which the thermal contraction rate is the lowest and a thermal contraction rate C2 in a direction in which the thermal contraction rate is the highest among directions along the surface may be larger than 10 ppm. Also, a difference (the absolute value thereof) between a thermal contraction amount S1 of the region in the direction in which the thermal contraction rate is the lowest and a thermal contraction amount S2 of the region in the direction in which the thermal contraction rate is the highest may be larger than 1.0 μm. Even in such a case where there is anisotropy in the thermal contraction rate, the annealed glass plate 10 satisfies the above-described range of the thermal contraction rate and the above-described range of the amount of change in the degree of flatness, and therefore, it is possible to suppress deterioration in the degree of flatness and deterioration in the roundness of a magnetic disk glass substrate obtained from the glass plate 10 when heat treatment is performed on a magnetic film on the magnetic disk glass substrate. The amount of change (deterioration) in the roundness is preferably 0.5 μm or less, and more preferably 0.2 μm or less.

According to an embodiment, it is preferable that a square measurement region that has a length of 100 mm per side and is cut out from the entire glass plate 10 including the end regions 11a and 11b of the glass plate 10 satisfies the above-described range of the degree of flatness, the above-described range of the thermal contraction rate, and the above-described range of the amount of change in the degree of flatness, similarly to the above-described measurement region 13. When compared with a case where magnetic disk glass substrates are manufactured from the central region 12, it is possible to obtain a larger number of magnetic disk glass substrates from such a glass plate 10.

As the material of the glass plate 10, it is preferable to use aluminosilicate glass, soda lime glass, soda aluminosilicate glass, aluminoborosilicate glass, borosilicate glass, or the like.

The glass transition temperature (Tg) of the glass plate 10 is preferably 750° C. or higher, and more preferably 770° C. or higher. A magnetic disk glass substrate manufactured from a glass plate 10 having such a high glass transition temperature (Tg) is unlikely to deform at high temperatures, and therefore, has a high effect of suppressing deterioration in the degree of flatness when heat treatment is performed on the magnetic film at 700° C., for example. Although the upper limit of the glass transition temperature (Tg) of the glass plate 10 need not be particularly set, the upper limit is preferably 850° C. or lower. When the glass transition temperature (Tg) is higher than 850° C., it may be difficult to form a thin sheet glass.

The glass plate 10 preferably has a Young's modulus of 80 GPa or more. When the Young's modulus is less than 80 GPa, the degree of flatness may significantly deteriorate due to the occurrence of warpage under the influence of elastic stress applied by the above-described support members for holding a substrate when heat treatment is performed on the magnetic film at 700° C., for example, in addition to the occurrence of warpage caused by the heat treatment. When the degree of flatness deteriorates excessively, a problem may occur, e.g., the substrate may fall off from the substrate holder during film deposition.

The glass plate 10 preferably has an average linear expansion coefficient of 45×10⁻⁷/° C. or less in a temperature range from 100° C. to 300° C. An average linear expansion coefficient higher than 45×10⁻⁷/° C. may increase the risk of the substrate cracking when it is rapidly heated or rapidly cooled to increase productivity.

The glass plate 10 preferably has a density of 2.65 g/cm³ or less, and more preferably 2.60 g/cm³ or less. When the density is excessively high, the weight of a magnetic disk glass substrate manufactured from the glass plate increases, and power consumption by an HDD is likely to increase.

### (Method for Manufacturing Glass Plate)

The glass plate 10 described above can be manufactured using a method for manufacturing a glass plate including annealing treatment in which a glass plate member, from which the glass plate 10 is obtained, is heated under predetermined conditions. In the following description, the annealing treatment performed on the glass plate member under the predetermined conditions will be referred to as “precise annealing”. The precise annealing is performed on the glass plate member such that the measurement region 13 of the glass plate 10 satisfies the above-described range of the thermal contraction rate and the above-described range of the amount of change in the degree of flatness.

The inventors of the present invention found through studies that, when a magnetic disk glass substrate is manufactured by cutting out a small glass plate from a conventional glass plate manufactured using any of the above-described methods such as the float method and heat treatment is performed on a magnetic film that serves as a magnetic recording layer on the magnetic disk glass substrate, the glass substrate warps due to thermal contraction and the degree of flatness of the magnetic disk deteriorates. A glass sheet formed using any of the above-described methods such as the float method is extended in various directions while being rapidly cooled in a state where the glass sheet has a large area, and accordingly it is difficult to keep the stress, temperature, and thermal history constant throughout the glass sheet, and it is difficult to uniformly reduce the thermal contraction rate throughout the glass sheet. It is thought that therefore, variation arises in the thermal contraction rate between different positions in a surface of the glass sheet. Accordingly when a portion of the glass sheet is cut out and thereafter heated, the portion may have a large thermal contraction amount. That is, in a case where the glass sheet is used as a glass substrate for an FPD, the glass sheet having a large area is used as is, and therefore, it is sufficient that a thermal contraction rate measured for the entire glass sheet falls within an allowable range, and there is no need to consider variation in the thermal contraction rate over the surface of the glass sheet. However, a magnetic disk glass substrate is very small compared with the glass substrate for an FPD, and it was found that a magnetic disk glass substrate having a high thermal contraction rate may be manufactured due to variation in the thermal contraction rate over the surface of the glass sheet. Additionally the temperature of heat treatment performed on a magnetic film formed on a magnetic disk glass substrate has increased in recent years, and may be 700° C. or higher, for example. This temperature is close to the glass transition temperature (Tg) of a glass substrate for uses that require a high degree of heat resistance. Conditions of such heat treatment performed on a magnetic film are very severe compared with conditions (e.g., 350° C. to 600° C.) under which a glass substrate for an FPD is heated to form a TFT on the glass substrate. It was found that accordingly even a low thermal contraction rate that is reduced by performing annealing in the formation of the glass sheet and does not cause any problem in the case where the glass sheet is used for a glass substrate for an FPD has a significant adverse effect when heat treatment is performed on the magnetic film. That is, it was found that, when heat treatment is performed on the magnetic film, the glass substrate significantly contracts due to heat or warps through thermal contraction. The inventors of the present invention found that, when the precise annealing described above is performed on the glass plate member from which the glass plate 10 is obtained, it is possible to precisely eliminate variation in the thermal contraction rate over the surface of the glass plate while keeping the degree of flatness of the glass plate 10 at a predetermined value or less, i.e., it is possible to obtain the above-described glass plate 10 including the measurement region 13 having a thermal contraction rate and an amount of change in the degree of flatness that fall within the predetermined ranges.

The inventors of the present invention carried out further studies and found that the following problem occurs even when conventionally-known common annealing treatment such as off-line annealing is performed to deal with the above-described problem, i.e., the glass substrate warps due to thermal contraction that occurs when heat treatment is performed on the magnetic film. That is, it was found that, when common annealing treatment is performed on a glass plate member from which a large glass plate is obtained, effects of the annealing treatment (e.g., the effect of reducing the thermal contraction rate) are not uniformly obtained throughout a surface of the glass plate member, and consequently even when the large glass plate as a whole has a thermal contraction rate not higher than a predetermined value when the above-described first heat treatment is performed, when a plurality of rectangular glass plates having a length of, for example, 95 to 120 mm per side are cut out (divided) from the large glass plate, the divided glass plates include a glass plate having a thermal contraction rate higher than the predetermined value or a magnetic disk glass substrate manufactured from any of the divided glass plates warps when heat treatment is performed on the magnetic film, and there arises variation in properties between the plurality of divided glass plates. It was found that particularly in the case where the glass plate member from which the glass plate 10 is obtained is a portion cut out from a glass sheet that is formed using any of the above-described methods such as the float method and the downdraw method, the above-described variation may arise between magnetic disk glass substrates manufactured by being cut out from a central region of the glass sheet excluding end regions near respective sides of the glass sheet. As for the central region of the large glass plate, it is not possible to directly measure the effects of the annealing treatment on a region that is included in the central region and is narrower than the central region, and therefore, even if the effects of the annealing treatment are low in a region of the central region, it is not possible to notice the presence of such a region. The inventors of the present invention carried out studies to find out reasons as to why such variation arises even when common annealing treatment is performed, and found that the variation is presumably affected mainly by a slight difference in thermal history between a portion near the outer periphery of the glass plate member and a central portion of the glass plate member during the annealing treatment. It was found that, as long as the central portion (central region) of the large glass plate is continuous to an outer peripheral portion (end regions) surrounding the central portion, the outer peripheral portion hinders thermal contraction of the central portion by restricting movement of the central portion, or the central portion excessively contracts under the influence of thermal contraction of the outer peripheral portion, and therefore, it is not possible to know an accurate thermal contraction rate of the central portion of the large glass plate unless the target portion is cut out. The inventors of the present invention found that, when the glass plate 10 is obtained by performing the above-described precise annealing, it is possible to solve the problem of variation in the effects of the annealing treatment, and suppress variation in properties between divided glass plates taken out from the central region 12 of the glass plate 10. Accordingly the measurement region 13 is cut out from the central region 12 of the glass plate 10 as described above. The sizes of the end regions 11a and 11b that determine the size of the central region 12 are determined from the viewpoint of suppressing the above-described variation in the thermal contraction rate and the amount of change in the degree of flatness between the plurality of divided glass plates.

For the reasons described above, the precise annealing is performed on the glass plate member such that the measurement region 13 of the glass plate 10 satisfies the above-described range of the thermal contraction rate and the above-described range of the amount of change in the degree of flatness. In the precise annealing, heat treatment is preferably performed at a temperature higher than or equal to Tg-110° C. for 4 hours or longer, and more preferably performed at a temperature higher than or equal to Tg-80° C. for 4 hours or longer. Conditions of this heat treatment are determined with reference to conditions under which heat treatment is performed on a magnetic film. In the precise annealing, heating (temperature raising), temperature maintaining, and cooling (temperature lowering) are preferably performed successively in an atmosphere under the same conditions (e.g., in an atmosphere in the same annealing furnace) except for the temperature conditions. Heating in the precise annealing is preferably performed for 2.5 hours starting from room temperature (normal temperature). In other words, the glass plate member is preferably heated from room temperature to a temperature higher than or equal to Tg-110° C., or more preferably to a temperature higher than or equal to Tg-80° C. at a rate of 270° C./hour. Cooling (temperature lowering) is preferably performed from the temperature higher than or equal to Tg-110° C., or more preferably from the temperature higher than or equal to Tg-80° C. to room temperature at a rate of 50° C./hour.

The precise annealing is preferably performed using a plate member (hereinafter referred to as a “setter”) for annealing treatment described below. In this case, it is possible to efficiently obtain the glass plate 10 satisfying the above-described range of the degree of flatness, the above-described range of the thermal contraction rate, and the above-described range of the amount of change in the degree of flatness.

The setter has the shape of a plate having two main surfaces, and is configured such that at least one surface comes into contact with a main surface of the glass plate member from which the glass plate 10 is obtained. The main surface of the setter is larger than the main surface of the glass plate member from which the glass plate 10 is obtained, and protrudes from the entire circumference of the glass plate member. The main surface of the setter protrudes by a length of, for example, 5 cm or more from the glass plate member in a direction away from the center of the glass plate member.

In order to efficiently obtain the glass plate 10 having the degree of flatness of 30 μm or less, the degree of flatness of the setter is preferably less than 30 μm, more preferably 20 μm or less, and further preferably 10 μm or less.

The setter has a heat conductivity of 1 to 200 W/(m·K) at 20° C., for example. When the heat conductivity of the setter is within this range, the glass plate member from which the glass plate 10 is obtained is likely to be uniformly heated and cooled in the precise annealing, and it is possible to effectively suppress variation in the thermal contraction rate after the precise annealing between different positions in the surface of the glass plate 10.

Examples of the material of the setter include alumina (Al₂O₃), silicon carbide (SiC), silicon nitride (Si₃N₄), zirconia (ZrO₂), sialon (Si₃N₄·Al₂O₃), steatite, spinel, and cordierite. Among these, alumina (Al₂O₃) and silicon carbide (SiC) are preferably used.

As an example of the precise annealing performed using the setter, there is a method in which two setters and a heat insulating material are used. According to an embodiment, the precise annealing is preferably performed in a state where the glass plate member is sandwiched between two setters having main surfaces larger than the glass plate member and surrounded by a heat insulating material placed in a gap between the setters. The heat insulating material is preferably constituted by a fiber material having a high degree of heat resistance. As the fiber material, inorganic fiber such as ceramic fiber or glass fiber is preferably used, as well as rock wool described below. In this example, the precise annealing is performed in a state where the two setters and the glass plate member are stacked so as to sandwich the glass plate member between the two setters having an area larger than the glass plate member and the space between the two setters, which is adjacent to side surfaces (edge surfaces) of the glass plate member, is filled with rock wool having a high degree of heat resistance. Here, the two setters have the same shape and are placed in such a manner as to exactly overlap each other as viewed in the thickness direction (i.e., not displaced from each other in a direction along their surfaces) with the glass plate member sandwiched therebetween, and outer peripheral portions of the setters protrude substantially uniformly from the entire circumference of the glass plate member, and thus a gap is formed between the two setters in the vicinity of the entire edge surfaces of the glass plate member. The rock wool having a high degree of heat resistance is gently packed into the gap to cover the entire glass plate member with the setters and the rock wool and to uniformly apply an adequate load from the setters to the main surfaces of the glass plate member.

The weight applied to the glass plate member in the precise annealing of this example is small when compared with a case where the precise annealing is performed on a stack obtained by alternately stacking a plurality of setters and a plurality of glass plate members, and therefore, it is possible to suppress the occurrence of a situation in which expansion or contraction of a glass plate member in a direction along its surface is hindered due to the influence of the weight of setters and glass plate members located above the glass plate member, and this contributes to reducing the thermal contraction rate irrespective of positions in the surface of the glass plate 10.

The rock wool has air-permeability as well as heat resistance, and accordingly the gap between the setters can be favorably filled with rock wool. As a result, it is easy to uniformly heat or cool the entire glass plate member (make the temperature uniform), and it is possible to reduce the thermal contraction rate irrespective of positions in the surface of the glass plate member.

Also, the rock wool is used to such an extent that application of a load to the glass plate member from the setter placed on the glass plate member is not hindered. Accordingly an adequate load is uniformly applied from the setter to the main surface of the glass plate member, and it is possible to suppress deterioration in the degree of flatness of the glass plate member during the precise annealing, and to reduce the degree of flatness depending on situations.

In other words, with the above-described method, it is possible to suppress the influence of the weight of the setter on the glass plate member to reduce the thermal contraction rate of the glass plate 10 irrespective of positions in its surface, and at the same time, it is possible to increase an effect of reducing the degree of flatness of the glass plate member.

The precise annealing described above can be performed on not only the plate member from which the glass plate 10 is obtained but also a divided glass plate from which a glass plate 20 is obtained as described below.

The glass plate 10 can be manufactured using the method for manufacturing a glass plate including the precise annealing described above.

### (Divided Glass Plate)

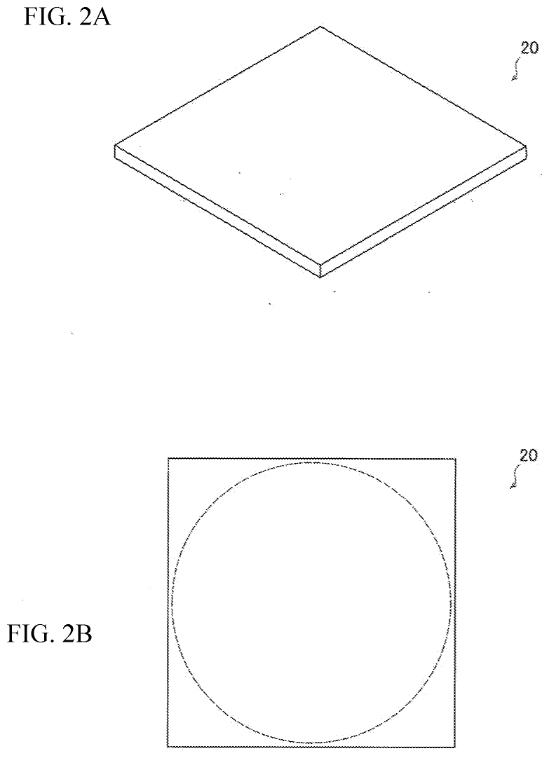

FIG. 2A is a diagram showing the appearance of the glass plate 20 according to an embodiment. FIG. 2B is a plan view of the glass plate 20 in which a portion to be formed into a disk-shaped glass is shown with a broken line.

The glass plate 20 is a rectangular plate having a thickness less than 0.68 mm, a degree of flatness of 30 μm or less, and two sides that are orthogonal to each other and each have a length of 95 to 120 mm. The glass plate is smaller than the glass plate (large glass plate) 10 described above, and may also be referred to as a “divided glass plate” in the present specification.

The glass plate 20 is a rectangular plate having a length of 95 to 120 mm per side. The size of the glass plate 20 is suitable for manufacturing a disk-shaped glass (which will be described later) from which a magnetic disk glass substrate is obtained, and for manufacturing the magnetic disk glass substrate, because an allowance can be reduced when the glass plate 20 is used to manufacture the disk-shaped glass and the magnetic disk glass substrate. Preferably the glass plate 20 is a square plate. When the precise annealing is performed on a glass plate member from which the square glass plate 20 is obtained, it is easy to reduce the thermal contraction rate and suppress anisotropy in the thermal contraction rate for the same reasons as those described above. Note that a case where the length and the width of the glass plate slightly differs (e.g., the ratio between the length and the width is 0.95 to 1.05) is also included in the above-described case where the glass plate is a square plate.

The thickness of the glass plate 20 is preferably less than 0.61 mm, and more preferably less than 0.58 mm. The lower limit of the thickness is not particularly limited, and is, for example, 0.2 mm.

When the glass plate 20 is subjected to the first heat treatment in which the glass plate 20 is kept at 700° C. for 4 hours and then cooled from 700° C. to 400° C. at a rate of 50° C./hour, the glass plate 20 has a thermal contraction rate of 130 ppm or less. The thermal contraction rate is preferably 90 ppm or less, and more preferably 50 ppm or less. When the glass plate 20 is subjected to the second heat treatment in which the glass plate 20 is kept at Tg-160° C. for 60 seconds and then cooled to room temperature in ambient air, where Tg (° C.) represents the glass transition temperature of the glass plate 20, the amount of change in the degree of flatness of the glass plate 20 is 10 μm or less. The amount of change in the degree of flatness is preferably 7.5 μm or less, and more preferably 5 μm or less.

The glass plate 20 is a glass blank from which a disk-shaped glass is obtained. The area of a main surface of the glass plate 20 is preferably not larger than 1.6 times the area inside an outer circumferential edge of the disk-shaped glass, and more preferably not larger than 1.5 times the area inside the outer circumferential edge of the disk-shaped glass. When the area of the main surface of the glass plate 20 is close to the area inside the outer circumferential edge of the disk-shaped glass (the influence of an inner hole is small and negligible), the disk-shaped glass is likely to have the above-described two properties of the glass plate 20, i.e., the thermal contraction rate and the amount of change in the degree of flatness. In other words, those properties of the disk-shaped glass do not largely differ from the above-described properties of the glass plate 20 from which the disk-shaped glass is cut out. This effect is particularly high in the case where the glass plate 20 is manufactured by performing the precise annealing on a divided glass plate member from which the glass plate 20 is obtained (i.e., performing the precise annealing after dividing processing). That is, the divided glass plate member has a small area, and accordingly effects of the precise annealing are likely to be achieved throughout an outer peripheral portion of the divided glass plate member, and there is small variation in the effects of the annealing treatment between different positions in a surface of the divided glass plate member. This increases the effect of suppressing deterioration in the degree of flatness of the disk-shaped glass cut out from the glass plate 20 when heat treatment is performed on a magnetic film formed on the disk-shaped glass. As described above, the closer the shape of the glass plate member subjected to the precise annealing is to the shape of the magnetic disk glass substrate, the higher the effects of the precise annealing become.

Note that the dividing processing refers to obtaining the divided glass plate 20 from the large glass plate 10 or obtaining a glass plate member having the same size as the divided glass plate 20 from the glass plate member from which the large glass plate 10 is obtained.

The glass plate 20 can be obtained by for example, cutting out the glass plate 20 from the glass plate 10 (already subjected to the precise annealing) or performing the precise annealing on a glass plate divided from the glass plate member from which the glass plate 10 is obtained.

Preferably the glass plate 20 is a glass plate that has been subjected to annealing treatment (e.g., the precise annealing described above) for reducing the thermal contraction rate. The glass plate prior to being subjected to the annealing treatment (the glass plate member from which the glass plate 20 is obtained) may have anisotropy in the thermal contraction rate, i.e., variation in the thermal contraction rate between different directions along a surface of the glass plate, and a difference (the absolute value thereof) between a thermal contraction rate C1 in a direction in which the thermal contraction rate is the lowest and a thermal contraction rate C2 in a direction in which the thermal contraction rate is the highest among directions along the surface may be larger than 10 ppm. Also, a difference (the absolute value thereof) between a thermal contraction amount S1 of the glass plate in the direction in which the thermal contraction rate is the lowest and a thermal contraction amount S2 of the glass plate in the direction in which the thermal contraction rate is the highest may be larger than 1.0 μm.

As for the glass plate 20, a difference (the absolute value thereof) between a thermal contraction rate C1 in a direction in which the thermal contraction rate is the lowest and a thermal contraction rate C2 in a direction in which the thermal contraction rate is the highest among directions along a surface of the glass plate 20 is preferably 10 ppm or less. Also, a difference (the absolute value thereof) between a thermal contraction amount S1 in the direction in which the thermal contraction rate is the lowest and a thermal contraction amount S2 in the direction in which the thermal contraction rate is the highest is preferably 1.0 μm or less.

The above-described glass plate 20 is manufactured by cutting out a divided glass plate from the large glass plate 10, for example. The glass plate 20 may be cut out using a well-known method in which a cutting line is formed using a scriber (cutter) and the large glass plate is split, or may be separated from the large glass plate 10 by irradiating the large glass plate 10 with a laser beam to form defects or the like at constant intervals and thereafter connecting those defects. The glass plate 20 is preferably cut out from the central region 12 of the large glass plate 10. Accordingly it is preferable that at least one main surface of the glass plate 20 is a fire finished surface. In this case, it is possible to omit one of grinding processing and polishing processing, which commonly need to be performed on a main surface of a magnetic disk glass substrate in manufacturing the magnetic disk glass substrate, or reduce the grinding allowance or polishing allowance. In other words, at least one main surface of the glass plate 20 is preferably a non-ground and/or non-polished surface.

It is also possible to manufacture the glass plate 20 by obtaining a divided glass plate member from the glass plate member that has not been subjected to the precise annealing and from which the large glass plate 10 is obtained, and thereafter performing precise annealing on the divided glass plate member. That is, the glass plate 20 can be manufactured using a method for manufacturing a glass plate including the precise annealing performed on the divided glass plate member from which the glass plate 20 is obtained.

In this method, the precise annealing is performed in the same manner as the above-described precise annealing performed on the large glass plate 10, by heating the divided glass plate member from which the glass plate 20 is obtained. The divided glass plate member used in this method to obtain the glass plate 20 is cut out from the glass plate member from which the large glass plate 10 is obtained, without the precise annealing being performed, and has substantially the same dimensions and shape as the glass plate 20.

The inventors of the present invention found through studies that, when the precise annealing is performed on the divided glass plate member from which the glass plate 20 is obtained, the thermal contraction rate and the amount of change in the degree of flatness of the obtained glass plate 20 can be further reduced when compared with the case where the glass plate 20 is cut out from a large glass plate 10 already subjected to the precise annealing. Therefore, it is possible to obtain a glass plate 20 having a lower thermal contraction rate and a smaller amount of change in the degree of flatness by performing the precise annealing on the divided glass plate member from which the glass plate 20 is obtained.

### (Disk-Shaped Glass)

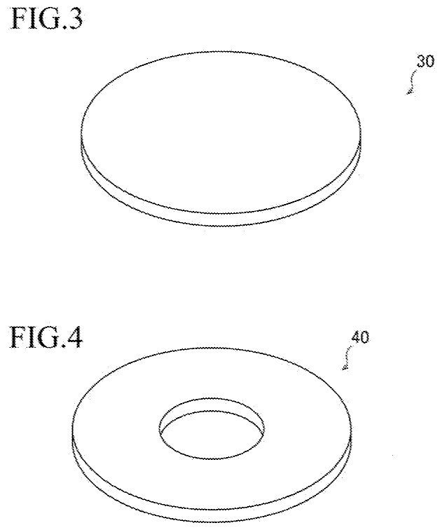

FIG. 3 is a diagram showing the appearance of a disk-shaped glass 30 according to an embodiment.

The disk-shaped glass 30 is a glass blank from which a magnetic disk glass substrate is obtained, for example.

The disk-shaped glass 30 has a circular outer circumferential edge. The disk-shaped glass may have a ring shape and include a through hole (inner hole) extending in its thickness direction in a central portion thereof, but a configuration is also possible in which the disk-shaped glass does not include an inner hole, as is the case with the disk-shaped glass 30 shown in FIG. 3.

The disk-shaped glass 30 has a thickness less than 0.68 mm and a degree of flatness of 30 μm or less.

When the disk-shaped glass 30 is subjected to the first heat treatment in which the disk-shaped glass 30 is kept at 700° C. for 4 hours and then cooled from 700° C. to 400° C. at a rate of 50° C./hour, the disk-shaped glass 30 has a thermal contraction rate of 130 ppm or less. The thermal contraction rate is preferably 90 ppm or less, more preferably 60 ppm or less, and further preferably 50 ppm or less. When the disk-shaped glass 30 is subjected to the second heat treatment in which the disk-shaped glass 30 is kept at Tg-160° C. for 60 seconds and then cooled to room temperature in ambient air, where Tg (° C.) represents the glass transition temperature of the disk-shaped glass 30, the amount of change in the degree of flatness is 10 μm or less. The amount of change in the degree of flatness is preferably 7.5 μm or less, more preferably 6 μm or less, and further preferably 5 μm or less.

The thickness of the disk-shaped glass 30 is preferably less than 0.61 mm, and more preferably less than 0.58 mm. The lower limit of the thickness is not particularly limited, and is, for example, 0.2 mm.

A difference (the absolute value thereof) between a thermal contraction rate C1 of the disk-shaped glass 30 in a direction in which the thermal contraction rate is the lowest and a thermal contraction rate C2 of the disk-shaped glass 30 in a direction in which the thermal contraction rate is the highest among directions along a surface of the disk-shaped glass 30 is preferably 10 ppm or less. The difference (C2−C1) is more preferably 7 ppm or less, and further preferably 5 ppm or less. Also, a difference (the absolute value thereof) between a thermal contraction amount S1 in the direction in which the thermal contraction rate is the lowest and a thermal contraction amount S2 in the direction in which the thermal contraction rate is the highest is preferably 1.0 μm or less. The difference (S2−S1) is more preferably 0.7 μm or less, and further preferably 0.5 μm or less.

The disk-shaped glass 30 is obtained by being cut out from the glass plate 20, for example.

The disk-shaped glass 30 can be cut out from the glass plate 20 by using a known scribing method or a known coring method, for example. The scribing method can be performed using a diamond scriber, a scribing wheel, a laser, or the like, for example. Accordingly at least one main surface of the disk-shaped glass 30 is preferably a fire finished surface. In this case, it is possible to omit one of grinding processing and polishing processing, which commonly need to be performed on a main surface of a magnetic disk glass substrate in manufacturing the magnetic disk glass substrate, or reduce the grinding allowance or polishing allowance. In other words, at least one main surface of the disk-shaped glass 30 is preferably a non-ground and/or non-polished surface.

In the case where the disk-shaped glass 30 is used as a glass blank (intermediate body) from which a magnetic disk glass substrate is to be obtained, the diameter of the disk-shaped glass 30 is preferably adjusted according to the size of the magnetic disk glass substrate to be obtained as a final product. The following numerical values and numerical value ranges are all examples. When the disk-shaped glass is used as a glass blank from which a glass substrate for a magnetic disk having a nominal diameter of 3.5 inches is to be obtained, the outer diameter can be set to 95 to 100 mm. In the case where an inner hole is provided, the inner diameter can be set to 23 to 25 mm. When the disk-shaped glass is used as a glass blank from which a glass substrate for a magnetic disk having a nominal diameter of 2.5 inches is to be obtained, the outer diameter can be set to 65 to 70 mm. In the case where an inner hole is provided, the inner diameter can be set to 18 to 20 mm.

### (Magnetic Disk Glass Substrate)

FIG. 4 is a diagram showing the appearance of a magnetic disk glass substrate 40 according to an embodiment. The magnetic disk glass substrate 40 shown in FIG. 4 includes an inner hole in a central portion.

Although there is no limitation on the size of the glass substrate 40, the glass substrate 40 has the size of, for example, a glass substrate for a magnetic disk having a nominal diameter of 3.5 inches or 2.5 inches. In the case of a glass substrate for a magnetic disk having a nominal diameter of 3.5 inches, the outer diameter can be set to 95 to 100 mm, for example, and the diameter of the inner hole can be set to 24 to 26 mm, for example. Specifically the outer diameter is 95 mm or 97 mm and the diameter of the inner hole is 25 mm, for example. On the other hand, in the case of a glass substrate for a magnetic disk having a nominal diameter of 2.5 inches, the outer diameter can be set to 65 to 70 mm, for example, and the diameter of the inner hole can be set to 19 to 21 mm, for example. Specifically the outer diameter is 65 mm or 67 mm and the diameter of the inner hole is 20 mm, for example.

The magnetic disk glass substrate 40 has a thickness less than 0.68 mm and a degree of flatness of 30 μm or less.

When the magnetic disk glass substrate 40 is subjected to the first heat treatment in which the magnetic disk glass substrate 40 is kept at 700° C. for 4 hours and then cooled from 700° C. to 400° C. at a rate of 50° C./hour, the magnetic disk glass substrate 40 has a thermal contraction rate of 130 ppm or less. The thermal contraction rate is preferably 90 ppm or less, more preferably 60 ppm or less, and further preferably 50 ppm or less. When the magnetic disk glass substrate 40 is subjected to the second heat treatment in which the magnetic disk glass substrate 40 is kept at Tg-160° C. for 60 seconds and then cooled to room temperature in ambient air, where Tg (° C.) represents the glass transition temperature of the magnetic disk glass substrate 40, the amount of change in the degree of flatness is 10 μm or less. The amount of change in the degree of flatness is preferably 7.5 μm or less, more preferably 6 μm or less, and further preferably 5 μm or less.

The thickness of the magnetic disk glass substrate 40 is preferably less than 0.61 mm, and more preferably less than 0.58 mm. The lower limit of the thickness is not particularly limited, and is, for example, 0.2 mm.

A difference (the absolute value thereof) between a thermal contraction rate C1 of the magnetic disk glass substrate 40 in a direction in which the thermal contraction rate is the lowest and a thermal contraction rate C2 of the magnetic disk glass substrate 40 in a direction in which the thermal contraction rate is the highest among directions along a surface of the magnetic disk glass substrate 40 is preferably 10 ppm or less. The difference (C2−C1) is more preferably 7 ppm or less, and further preferably 5 ppm or less. Also, a difference (the absolute value thereof) between a thermal contraction amount S1 in the direction in which the thermal contraction rate is the lowest and a thermal contraction amount S2 in the direction in which the thermal contraction rate is the highest is preferably 1.0 μm or less. The difference (S2−S1) is more preferably 0.7 μm or less, and further preferably 0.5 μm or less.

The magnetic disk glass substrate 40 is obtained by using a method for manufacturing a magnetic disk glass substrate including processing for grinding and/or polishing a main surface of the disk-shaped glass 30, for example. The method for manufacturing a magnetic disk glass substrate may also include processing for forming chamfered surfaces, grinding and/or polishing edge surfaces, chemical strengthening, washing, and the like, in addition to the processing for grinding and/or polishing a main surface of the disk-shaped glass 30. In the case where the magnetic disk glass substrate 40 is manufactured from a disk-shaped glass 30 that does not include an inner hole, the method for manufacturing a magnetic disk glass substrate may also include processing for forming an inner hole in the disk-shaped glass 30 (e.g., by using the above-described scribing method or a coring method in which a core drill is used).

The method for manufacturing a magnetic disk glass substrate is performed as described below, for example. Chamfered surfaces are formed in an inner circumferential edge surface and an outer circumferential edge surface of the disk-shaped glass 30 having a ring shape. Next, a main surface of the disk-shaped glass provided with the chamfered surfaces is ground. In the grinding processing, the main surface of the disk-shaped glass is ground with use of a grinding member obtained by forming a sheet of fixed abrasive particles or a slurry containing loose abrasive particles. Next, the ground main surface of the disk-shaped glass is polished. In the polishing processing, the main surface is polished with use of a polishing pad and a slurry containing loose abrasive particles having a smaller particle diameter than the loose abrasive particles used in the grinding processing. The polishing processing can be performed in a plurality of steps by using abrasive particles with different particle diameters or polishing pads with different degrees of rigidity.

In the case where chemical strengthening is performed, chemical strengthening is preferably performed before or after the last processing included in the polishing processing, for example. The chemical strengthening processing is performed by immersing the disk-shaped glass in a melt of a mixture of multiple types of nitrates, for example. In the washing, the disk-shaped glass is washed with a cleaning liquid after the chemical strengthening or the last processing included in the polishing processing. Note that washing processing may be added as appropriate between any of the above-described processing steps.

### Experimental Example 1

In order to confirm the effects of the present invention, various magnetic disk glass substrates (Conventional Example 1 and Examples 1 to 5) shown below in Tables were manufactured, and evaluated in terms of the thermal contraction rate and the amount of change in the roundness when the substrates were subjected to the above-described first heat treatment and deterioration in the degree of flatness when the substrates were subjected to the above-described second heat treatment. Note that the difference (C2−C1) between thermal contraction rates, the difference (S2−S1) between thermal contraction amounts, and an angle between a direction in which the thermal contraction rate was the highest and a direction in which the thermal contraction rate was the lowest were also evaluated to evaluate anisotropy in the thermal contraction rate. However, in cases where the difference (S2−S1) between thermal contraction amounts was 0.5 μm or less, it can be determined that the anisotropy is very small, and therefore, the angle was not measured in those cases.

TABLE 1

| | Conventional Ex. 1 | Ex. 1 | Ex. 2 |
|---|---|---|---|
| Precise annealing | Not performed | Performed | Performed |
| Timing of precise annealing | — | Before dividing | After dividing |
| | | (large glass plate) | |
| Shape and size of divided glass plate | Square | Square | Square |
| | 109 × 109 mm | 109 × 109 mm | 109 × 109 mm |
| Area ratio between divided glass plate and disk-shaped glass | 1.54 | 1.54 | 1.54 |
| Thermal contraction rate (ppm) | 370 | 130 | 50 |
| Amount of change in degree of flatness (μm) | 14 | 10 | 5 |
| Deterioration in degree of flatness | C | B | A |
| Difference (C2 − C1) between thermal contraction rates (ppm) | 13 | 9 | 4 |
| Difference (S2 − S1) between thermal contraction amounts (μm) | 1.2 | 0.8 | 0.4 |
| Angle (°) between direction in which thermal contraction rate | 57.6 | 50.4 | — |
| was highest and direction in which thermal contraction rate | | | |
| was lowest | | | |
| Amount of change in roundness (μm) | 0.6 | 0.4 | 0.2 |
| Deterioration in roundness | C | B | A |

TABLE 2

| | Ex. 3 | Ex. 4 | Ex. 5 |
|---|---|---|---|
| Precise annealing | Performed | Performed | Performed |
| Timing of precise annealing | After dividing | After dividing | After dividing |
| Shape and size of divided glass plate | Square | Square | Rectangle |
| | 106 × 106 mm | 112 × 112 mm | 118.3 × 106 mm |
| Area ratio between divided glass plate and disk-shaped glass | 1.46 | 1.63 | 1.63 |
| Thermal contraction rate (ppm) | 41 | 56 | 73 |
| Amount of change in degree of flatness (μm) | 4 | 6 | 7 |
| Deterioration in degree of flatness | A | A | A |
| Difference (C2 − C1) between thermal contraction rates (ppm) | 3 | 5 | 7 |
| Difference (S2 − S1) between thermal contraction amounts (μm) | 0.3 | 0.5 | 0.7 |
| Angle (°) between direction in which thermal contraction rate | — | — | 72 |
| was highest and direction in which thermal contraction rate | | | |
| was lowest | | | |
| Amount of change in roundness (μm) | 0.15 | 0.3 | 0.4 |
| Deterioration in roundness | A | B | B |

Specifications of the magnetic disk glass substrates of Conventional Example 1 and Examples 1 to 5 were as follows.
aluminosilicate glass having a glass transition temperature (Tg) of 810° C.
outer diameter: 97 mm, inner diameter: 25 mm, thickness: 0.5 mm, and degree of flatness of main surface: 5 μm

Note that, in all of the magnetic disk glass substrates manufactured in Examples, an average value of retardation in the main surface was 0.5 nm or less. That is, residual stress in the magnetic disk glass substrates manufactured in Examples was sufficiently small, and therefore, it is thought that the residual stress had almost no influence on the various evaluations.

The glass substrates of Conventional Example 1 and Examples 1 to 5 were manufactured as described below.

### Conventional Example 1

From a glass sheet annealed while being formed by using an overflow downdraw method, both end portions in a width direction that were thicker than a central portion in the width direction were cut off, and a predetermined region of the glass sheet was cut out from the remaining portion of the glass sheet to obtain a rectangular glass plate member having short sides with a length of 1000 mm, long sides with a length of 1200 mm, and a thickness of 0.6 mm. The long-side direction of the glass plate member was the width direction of the glass sheet. A divided square glass plate member (divided glass plate) having a length of 109 mm per side was cut out from a central region of the obtained glass plate member excluding end regions of the glass plate member extending inward from respective edges in the short-side direction with a length of 200 mm and end regions of the glass plate member extending inward from respective edges in the long-side direction with a length of 200 mm.

Thereafter, a disk-shaped glass having a diameter of 99 mm was cut out from the divided glass plate using a scribing method. At this time, a ratio between the area of the divided glass plate and the area of the disk-shaped glass was about 1.54. Thereafter, a magnetic disk glass substrate having the above-described specifications was obtained by forming a circular hole and chamfered surfaces, adjusting the outer diameter and the inner diameter, polishing edge surfaces, grinding and polishing a main surface, and washing the substrate using known methods, for example.

### Example 1

A magnetic disk glass substrate was obtained in the same manner as in Conventional Example 1, other than that the above-described precise annealing was performed on the rectangular glass plate member (large plate) having short sides with a length of 1000 mm, long sides with a length of 1200 mm, and a thickness of 0.6 mm.

### Example 2

A magnetic disk glass substrate was obtained in the same manner as in Conventional Example 1, other than that the precise annealing was performed on the divided glass plate member.

### Example 3

A magnetic disk glass substrate was obtained in the same manner as in Example 2, other than that the size of the divided glass plate was changed to 106 mm×106 mm and the ratio between the area of the divided glass plate and the area of the disk-shaped glass was about 1.46.

### Example 4

A magnetic disk glass substrate was obtained in the same manner as in Example 2, other than that the size of the divided glass plate was changed to 112 mm×112 mm and the ratio between the area of the divided glass plate and the area of the disk-shaped glass was about 1.63.

### Example 5

A magnetic disk glass substrate was obtained in the same manner as in Example 4, other than that the divided glass plate had a rectangular shape and a size of 118.3 mm×106 mm.

The precise annealing was performed by placing the glass plate member in an annealing furnace for 4 hours with the temperature of an atmosphere inside the furnace adjusted to 700° C. (Tg-110° C.). More specifically the temperature was raised to 700° C. for 2.5 hours, kept at 700° C. for 4 hours, and then lowered at a rate of 50° C./hour. At this time, the glass plate member was sandwiched between two setters having main surfaces larger than the glass plate member in such a manner that outer peripheral portions of the setters protruded from the entire circumference of the glass plate member by 5 cm, and rock wool was gently packed into a gap between the two setters adjacent to side surfaces of the glass plate member to cover the entire glass plate member with the setters and the rock wool.

### <Measurement of Thermal Contraction Rate and Amount of Change in Roundness>

First heat treatment described below was performed on each glass substrate that was a measurement target.

### (First Heat Treatment)

The glass substrate was placed in an annealing furnace at room temperature, the temperature was raised to 700° C., the glass substrate was kept at 700° C. for 4 hours, and then cooled from 700° C. to 400° C. at a rate of 50° C./hour.

A thermal contraction rate was calculated from an amount of change in the diameter measured before and after the first heat treatment in each of 25 directions that were set at central angle intervals of 7.2° in a circumferential direction about the center of the glass substrate so as to pass through the center, and the largest value of the calculated thermal contraction rates was taken to be the thermal contraction rate of the glass substrate.

The difference (C2−C1) between thermal contraction rates is a difference (the absolute value thereof) between a thermal contraction rate C1 in a direction in which the thermal contraction rate was the lowest and a thermal contraction rate C2 in a direction in which the thermal contraction rate was the highest among the 25 directions described above. The difference (S2−S1) between thermal contraction amounts is a difference (the absolute value thereof) between a thermal contraction amount S1 in the direction in which the thermal contraction rate was the lowest and a thermal contraction amount S2 in the direction in which the thermal contraction rate was the highest among the 25 directions described above.

The amount of change in the roundness was calculated by subtracting a roundness before the first heat treatment from a roundness after the first heat treatment. The absolute value of the amount of change in the roundness was used in the evaluation. The roundness was measured by using a roundness meter. In principle, the roundness after the first heat treatment was larger than the roundness before the first heat treatment.

Deterioration in the roundness was evaluated as A in cases where the difference between the roundness of the outer circumferential edge of the glass substrate measured before the first heat treatment and the roundness of the outer circumferential edge of the glass substrate measured after the first heat treatment was 0.2 μm or less, B in cases where the difference was more than 0.2 μm and 0.5 μm or less, and C in cases where the difference was more than 0.5 μm. In the cases where deterioration in the roundness was evaluated as A and B, it was determined that deterioration in the roundness was suppressed.

### <Measurement of Amount of Change in Degree of Flatness>

Second heat treatment described below was performed on each glass substrate that was a measurement target.

### (Second Heat Treatment)

The glass substrate was placed in a heating device at room temperature, the temperature was raised to 650° C. (corresponding to Tg-160° C.) for 50 seconds, the glass substrate was kept at 650° C. for 60 seconds, then taken out from the device, and naturally cooled to room temperature in ambient air. A device including two panel heaters arranged parallel to each other with a distance therebetween as described above was used as the heating device. The glass substrate was attachable to a holding tool (substrate holder) in such a manner as to vertically stand in the space between the panel heaters. The holding tool (substrate holder) to which the glass substrate was attached was movable between the outside of the heating device, i.e., ambient air, and the inside of the heating device.

The amount of change in the degree of flatness was calculated by subtracting a degree of flatness before the second heat treatment from a degree of flatness after the second heat treatment. Absolute values of the degrees of flatness and the amount of change in the degree of flatness were used in the evaluation.

Deterioration in the degree of flatness was evaluated as Ain cases where the difference between the degree of flatness measured before the second heat treatment and the degree of flatness measured after the second heat treatment was 7 μm or less, B in cases where the difference was more than 7 μm and 10 μm or less, and C in cases where the difference was more than 10 μm. In the cases where deterioration in the degree of flatness was evaluated as A and B, it was determined that deterioration in the degree of flatness was suppressed.

Through comparison between Conventional Example 1 and Example 1, it can be found that, when the precise annealing is performed on the large plate before dividing the large plate, the thermal contraction rate in the first heat treatment can be reduced to be not higher than 130 ppm, and the amount of change in the degree of flatness due to the second heat treatment can be suppressed to be not larger than 10 μm. As for anisotropy in the thermal contraction rate, it can be found that the difference (C2−C1) between thermal contraction rates can be suppressed to be not larger than 10 ppm, and deterioration in the roundness of the glass substrate can also be suppressed.

Through comparison between Example 1 and Example 2, it can be found that, when the precise annealing is performed on the divided glass plate member, the effect of suppressing deterioration in the degree of flatness of the glass substrate is increased compared with the case where the precise annealing is performed on the large plate before dividing the large plate. It can be found that the effect of suppressing deterioration in the roundness of the glass substrate also increases.

Through comparison between Examples 2 to 4, it can be found that, when the ratio between the area of the divided glass plate and the area of the disk-shaped glass is 1.6 or less, or preferably 1.5 or less, the effect of reducing the thermal contraction rate in the first heat treatment and suppressing the amount of change in the degree of flatness due to the second heat treatment increases. As for anisotropy in the thermal contraction rate, it can be found that the difference (C2−C1) between thermal contraction rates decreases, and the effect of reducing the amount of change in the roundness of the glass substrate increases.

Through comparison between Example 4 and Example 5, it can be found that, in the case where the divided glass plate has a square shape, the effect of reducing the thermal contraction rate in the first heat treatment and suppressing the amount of change in the degree of flatness due to the second heat treatment is increased compared with the case where the divided glass plate does not have a square shape. As for anisotropy in the thermal contraction rate, it can be found that the difference (C2−C1) between thermal contraction rates decreases, and the effect of reducing the amount of change in the roundness of the glass substrate increases in the case where the divided glass plate has a square shape.

Note that the thermal contraction rate was measured for other magnetic disk glass substrates (a plurality of glass substrates) manufactured in the same manner as in Conventional Example 1 by changing the conditions of the first heat treatment; the temperature was raised from room temperature to 600° C. at a rate of 100° C./hour, kept at 600° C. for 80 minutes, and then lowered from 600° C. to room temperature at a rate of 100° C./hour. The magnetic disk glass substrates had a thermal contraction rate of 20 to 40 ppm, which is very low compared with the thermal contraction rate of the glass substrate of Conventional Example 1 subjected to the first heat treatment. It is thought that this is mainly because, in the conditions for measuring the thermal contraction rate, the heating temperature and the period of time for which the glass substrates were kept at the heating temperature were both mitigated. This indicates that the thermal contraction rate is considerably affected by the heating conditions of the measurement conditions.

### Experimental Example 2

Twenty magnetic disk glass substrates were manufactured under the same conditions as those adopted in Conventional Example 1, the thermal contraction rate (the highest thermal contraction rate in the above-described 25 directions) was measured for each substrate, and a difference (variation) between the highest thermal contraction rate and the lowest thermal contraction rate among thermal contraction rates of the 20 substrates was calculated and found to be 188 ppm.

Likewise, 20 magnetic disk glass substrates manufactured under the same conditions as those adopted in Example 1 were prepared, and a difference (variation) between the highest thermal contraction rate and the lowest thermal contraction rate among thermal contraction rates of the 20 substrates was calculated and found to be 37 ppm.

Likewise, 20 magnetic disk glass substrates manufactured under the same conditions as those adopted in Example 2 were prepared, and a difference (variation) between the highest thermal contraction rate and the lowest thermal contraction rate among thermal contraction rates of the 20 substrates was calculated and found to be 9 ppm.

The variation in the thermal contraction rate (difference between the highest value and the lowest value) was compared between Conventional Example 1, Example 1, and Example 2 in the same manner as that described above (Experimental Example 2), other than that the thermal contraction rate was measured for divided glass plates immediately before disk-shaped glass was cut out therefrom, instead of measuring the thermal contraction rate of the magnetic disk glass substrates, and the results were similar to those described above (Experimental Example 2).

From these results, it can be found that: (1) variation in the thermal contraction rate between divided glass plates decreases when the precise annealing is performed; and (2) the variation in the thermal contraction rate further decreases in the case where the precise annealing is performed on divided glass plates, compared with the case where the precise annealing is performed on the large glass plate.

Although the magnetic disk glass substrate, the disk-shaped glass plate, the glass plate, and the method for manufacturing a glass plate according to the present invention have been described in detail, it goes without saying that the present invention is not limited to the above embodiments and Examples, and various modifications and changes can be made within a scope not departing from the gist of the present invention.

1. A rectangular glass plate having a thickness less than 0.68 mm,
wherein a square measurement region having a length of 100 mm per side and cut out from a central region of the glass plate has a degree of flatness of 30 μm or less, the central region being a region excluding: end regions of the glass plate extending inward from respective edges of the glass plate in a short-side direction, with a length that is 5% to 20% of a length of each short side of the glass plate; and end regions of the glass plate extending inward from respective edges of the glass plate in a long-side direction, with a length that is 5% to 20% of a length of each long side of the glass plate,
when the measurement region is subjected to first heat treatment in which the measurement region is kept at 700° C. for 4 hours and then cooled from 700° C. to 400° C. at a rate of 50° C./hour, the measurement region has a thermal contraction rate of 130 ppm or less, and
when the measurement region is subjected to second heat treatment in which the measurement region is kept at Tg-160° C. for 60 seconds and then cooled to room temperature in ambient air, where Tg (° C.) represents a glass transition temperature of the glass plate, an amount of change in the degree of flatness of the measurement region is 10 μm or less.

2. The glass plate according to claim 1,
wherein the length of each short side is more than 900 mm.

3. The glass plate according to claim 1,
wherein the glass plate is a portion cut out from an elongated glass sheet formed with use of any one of a float method, a Fourcault method, a Pittsburgh method, a downdraw method, a Colbum method, and a redraw method.

4. The glass plate according to claim 1,
wherein a difference between a thermal contraction amount S1 of the measurement region in a direction in which the thermal contraction rate is the lowest and a thermal contraction amount S2 of the measurement region in a direction in which the thermal contraction rate is the highest among directions along a surface of the measurement region is 1.0 μm or less.

5. The glass plate according to claim 1,
wherein the glass plate is a glass plate that has been subjected to annealing treatment for reducing the thermal contraction rate,
the glass plate prior to being subjected to the annealing treatment has anisotropy in the thermal contraction rate and variation in the thermal contraction rate between different directions along a surface of a region of the glass plate corresponding to the measurement region, and
a difference between a thermal contraction amount S1 of the region in a direction in which the thermal contraction rate is the lowest and a thermal contraction amount S2 of the region in a direction in which the thermal contraction rate is the highest among directions along the surface is larger than 1.0 μm.

6. A rectangular glass plate having a thickness less than 0.68 mm, a degree of flatness of 30 μm or less, and two sides that are orthogonal to each other and each have a length of 95 to 120 mm,
wherein, when the glass plate is subjected to first heat treatment in which the glass plate is kept at 700° C. for 4 hours and then cooled from 700° C. to 400° C. at a rate of 50° C./hour, the glass plate has a thermal contraction rate of 130 ppm or less, and
when the glass plate is subjected to second heat treatment in which the glass plate is kept at Tg-160° C. for 60 seconds and then cooled to room temperature in ambient air, where Tg (° C.) represents a glass transition temperature of the glass plate, an amount of change in the degree of flatness is 10 μm or less.

7. The glass plate according to claim 6,
wherein the rectangular glass plate is a glass blank from which a disk-shaped glass having a circular outer circumferential edge is obtained, and
an area of a main surface of the rectangular glass plate is not larger 1.6 times an area inside the outer circumferential edge of the disk-shaped glass.

8. (canceled)

9. A magnetic disk glass substrate having a thickness less than 0.68 mm, a degree of flatness of 30 μm or less, and a diameter of 95 to 100 mm,
wherein, when the magnetic disk glass substrate is subjected to first heat treatment in which the magnetic disk glass substrate is kept at 700° C. for 4 hours and then cooled from 700° C. to 400° C. at a rate of 50° C./hour, the magnetic disk glass substrate has a thermal contraction rate of 130 ppm or less, and
when the magnetic disk glass substrate is subjected to second heat treatment in which the magnetic disk glass substrate is kept at Tg-160° C. for 60 seconds and then cooled to room temperature in ambient air, where Tg (° C.) represents a glass transition temperature of the magnetic disk glass substrate, an amount of change in the degree of flatness is 10 μm or less.

10. The magnetic disk glass substrate according to claim 9,
wherein an amount of change in roundness due to the first heat treatment is 0.5 μm or less.

11. (canceled)

12. (canceled)

13. (canceled)

14. (canceled)

15. (canceled)

16. The rectangular glass plate according to claim 6,
wherein a difference between a thermal contraction amount S1 of the measurement region in a direction in which the thermal contraction rate is the lowest and a thermal contraction amount S2 of the measurement region in a direction in which the thermal contraction rate is the highest among directions along a surface of the measurement region is 1.0 μm or less.

17. The magnetic disk glass substrate according to claim 9,
wherein a difference between a thermal contraction amount S1 of the measurement region in a direction in which the thermal contraction rate is the lowest and a thermal contraction amount S2 of the measurement region in a direction in which the thermal contraction rate is the highest among directions along a surface of the measurement region is 1.0 μm or less.
